(19) United States
(12) Patent Application Publication
(10) Pub. No.: US 2002/0045032 A1
(43) Pub. Date: Apr. 18, 2002

(54) Method for manufacturing recording medium for ink-jet recording

(75) Inventor: Kiyoshi Endo, Tokyo (JP)

Correspondence Address: FRISHAUF, HOLTZ, GOODMAN,, LANGER & CHICK, P.C., 767 Third Avenue - 25th Floor, New York, NY, 10017-2023, US

(73) Assignee: KONICA CORPORATION, Tokyo (JP)

(21) Appl. No.: 09/860,153

(22) Filed: May 17, 2001

(30) Foreign Application Priority Data
May 24, 2000 (JP) 152858/2000

(51) Int. Cl. B41M 5/00

(52) U.S. Cl. 428/195

(57) ABSTRACT

A process for manufacturing a recording medium for ink-jet recording is disclosed which comprises the steps of 1) supplying continuously at least inorganic particles and an aqueous medium to a disperser; 2) dispersing the inorganic particles in the disperser to obtain an inorganic particle dispersion solution; 3) ejecting continuously the inorganic particle dispersion solution form the disperser, wherein the supplying, dispersing, and ejecting are carried out in the first dispersion stage; 4) providing a coating solution containing the resulting inorganic particle dispersion solution; and 5) coating solution on a support.

### FIELD OF THE INVENTION

The present invention relates to a manufacturing method of a recording medium for ink-jet recording (hereinafter referred to also as a recording medium), and particularly to a manufacturing method of a recording medium for ink-jet recording, which is free from coating defects and is excellent in productivity, glossiness and maximum density.

### BACKGROUND OF THE INVENTION

Ink-jet recording jets minute ink droplets on a recording sheet such as a paper sheet applying various principles, and records an image or text on it. This recording method has advantages in providing a relatively high speed recording, low noise and easy color image formation.

There have been problems in maintenance or ink clogging of nozzles in this method, but improvements have been made in both ink and device, and this method has been widely applied to various fields such as printers, facsimile and computer terminals.

It is required for ink recording sheet to provide printing dots with high density and bright image tone, to provide rapid ink absorption property producing no ink diffusion or blur in overlapped printing dots, and to provide printing dots with smooth periphery and no blurring in which printing ink is not so greatly diffused.

In the recording sheet slow in ink absorption, two or more kinds of color ink drops repel one another at overlapped ink recording portions on the sheet, resulting in image unevenness, or different color inks at different but nearest ink recording portions on the sheet are diffused and mixed, resulting in deterioration of image quality. Therefore, a recording sheet having high ink absorption property is required.

Many techniques have been proposed in order to solve the above described problems. There have been proposed, for example, an ink-jet recording sheet paper of low size content wetted with surface treatment coating disclosed in Japanese Patent O.P.I. Publication No. 52-53012, an ink-jet recording sheet paper comprising a support and provided thereon, an ink absorption layer disclosed in Japanese Patent O.P.I. Publication No. 55-5830, an ink-jet recording sheet paper comprising a layer containing non-colloidal silica powder as pigment disclosed in Japanese Patent O.P.I. Publication No. 56-157, an ink-jet recording sheet paper comprising an inorganic and organic pigment disclosed in Japanese Patent O.P.I. Publication No. 57-107878, an ink-jet recording sheet paper comprising two void distribution peaks disclosed in Japanese Patent O.P.I. Publication No. 58-110287, an ink-jet recording sheet paper comprising two upper and lower porous layers disclosed in Japanese Patent O.P.I. Publication No. 62-111782, an ink-jet recording sheet paper comprising amorphous cracks disclosed in Japanese Patent O.P.I. Publication Nos. 59-68292, 59-123696 and 60-18383, an ink-jet recording sheet paper comprising a fine powder layer disclosed in Japanese Patent O.P.I. Publication Nos. 61-135786, 61-148092 and 62-149475, an ink-jet recording sheet paper comprising pigments or fine particle silica each having a specific physical property disclosed in Japanese Patent O.P.I. Publication Nos. 63-252779, 1-108083, 2-136279, 3-65376 and 3-27976, an ink-jet recording sheet paper comprising fine particle silica such as colloidal silica disclosed in Japanese Patent O.P.I. Publication Nos. 57-14091, 60-219083, 60-210984, 61-20797, 61-188183, 5-278324, 6-92011, 6-183134, 7-137431 and 7-276789, or an ink-jet recording sheet paper comprising hydrated alumina fine particles disclosed in Japanese Patent O.P.I. Publication Nos. 2-276671, 3-67684, 3-215082, 3-251488, 4-67986, 4-263983 and 5-16517.

In order to improve water resistance of formed images in the ink-jet recording, a method of fixing an ink dye in the ink receiving layer containing a cationic substance is known, and is preferably used.

However, in the ink receiving layer having a void structure, when a cationic inorganic pigment, particularly a cationic colloidal silica is used as a substance forming the void structure, a high void content layer is difficult to form, or use of hydrated alumina fine particles as the substance results in manufacturing cost increase. The use of colloidal silica is advantageous in view of void layer forming ability and manufacturing cost. As silica particles are anionic, a cationic substance is required. There is disclosure in Japanese Patent O.P.I. Publication No. 10-181190, of a recording sheet providing high glossiness and high image density which is obtained by coating on a support a coating solution comprising a dispersion solution obtained by pulverizing and dispersing aggregated pigment (silica) in a cationic polymer-containing solution to give an average diameter of not more than 500 nm.

There is description in Japanese Patent O.P.I. Publication No. 10-181190 of a method in which silica is added while stirring to a cationic polymer-containing solution in a batch, dispersed in the batch (so-called batch dispersion), and then repeatedly dispersed in a sand grinder or a high speed homogenizer. However, this method is inferior in productivity, and is not satisfactory in view of glossiness and crack occurrence of a recording medium.

When inorganic particles are dispersed in a dispersion medium, the particles are easy to aggregate to form large particles (coagula), which results in problems in view of product quality of a recording medium. Particularly when a solution containing silica particles and a cationic polymer was first dispersed in a batch, the silica particles and the cationic polymer easily form coagula, and once coagula are formed, long time is required to disperse this formed coagula, resulting in lowering of productivity, and further, the aggregated large particles remained in the solution bring about lowering of glossiness and crack occurrence in the recording medium.

The final dispersion degree of the dispersion solution has an influence upon coatability or glossiness. Product quality cannot be controlled by only an average particle diameter measured by an electron microscope or a particle size measuring apparatus.

The coating defects such as cracks bring about a big problem to obtain a recording medium for ink-jet recording with high image quality and improved productivity. The above techniques have not provided satisfactory results.

### SUMMARY OF THE INVENTION

The present invention has been made in view of the above. An object of the invention is to provide a method for manufacturing a recording medium for ink-jet recording which can provide few cracks, high maximum density, excellent glossiness, and improved productivity.

### BRIEF EXPLANATION OF THE DRAWINGS

FIG. 1 is an illustration showing a conventional dispersion process used in Comparative example 1.

FIG. 2 is another illustration showing a conventional dispersion process.

FIG. 3 is a first illustration showing a complete continuous dispersion process in which plural continuous dispersers are connected in series.

FIG. 4 is a second illustration showing a complete continuous dispersion process in which plural continuous dispersers are connected in series.

FIG. 5 is a third illustration showing a complete continuous dispersion process in which plural continuous dispersers are connected in series.

FIG. 6 is a fourth illustration showing a complete continuous dispersion process in which plural continuous dispersers are connected in series.

FIG. 7 is a first illustration showing a batch continuous dispersion process in which a batch type disperser is used after a continuous dispersion process.

FIG. 8 is an illustration showing a complete continuous dispersion process in which a single continuous disperser is used.

FIG. 9 is a fifth illustration showing a complete continuous dispersion process in which plural continuous dispersers are connected in series.

FIG. 10 is a sixth illustration showing a complete continuous dispersion process in which plural continuous dispersers are connected in series.

FIG. 11 is a second illustration showing a batch continuous dispersion process in which a batch type disperser is used after a continuous dispersion process.

FIG. 12 is a third illustration showing a batch continuous dispersion process in which plural batch type dispersers are used after a continuous dispersion process.

FIG. 13 is a fourth illustration showing a batch continuous dispersion process in which plural batch type dispersers are used after a continuous dispersion process, and an aqueous medium is further added to the batch type dispersers.

### DETAILED DESCRIPTION OF THE INVENTION

The above object of the invention has been attained by the following constitutions:

1. A process for manufacturing a recording medium for ink-jet recording, the process comprising the steps of:

1) supplying continuously at least inorganic particles and an aqueous medium to a disperser;

2) dispersing the inorganic particles in the disperser to obtain an inorganic particle dispersion solution;

3) ejecting continuously the inorganic particle dispersion solution from the disperser, wherein the supplying, dispersing, and ejecting are carried out at the first dispersion stage;

4) providing a coating solution containing the resulting inorganic particle dispersion solution; and

5) coating the coating solution on a support.

2. The process of item 1 above, wherein the disperser is a kneading disperser or a pulverizing disperser.

3. The process of item 1 above, wherein the inorganic particle dispersion solution has a turbidity of not more than 50 ppm.

4. The process of item 1 above, wherein the inorganic particle dispersion solution further contains a cationic polymer.

5. The process of item 1 above, wherein the inorganic particles are silica particles.

6. A process for manufacturing a recording medium for ink-jet recording, the process comprising the steps of:

1) supplying continuously at least inorganic particles and an aqueous medium to a first disperser;

2) dispersing the inorganic particles in the first disperser to obtain a first inorganic particle dispersion solution;

3) ejecting continuously the first inorganic particle dispersion solution from the first disperser;

4) supplying continuously the ejected first dispersion solution to a second disperser;

5) dispersing the first dispersion solution in the second disperser to obtain a second inorganic particle dispersion solution;

6) ejecting continuously the second inorganic particle dispersion solution from the second disperser, wherein the steps 1), 2), 3), 4), 5) and 6) are carried out at the first dispersion stage;

7) providing a coating solution containing the resulting inorganic particle dispersion solution; and

8) coating the coating solution on a support.

7. The process of item 6 above, wherein the first disperser and the second disperser are connected in series.

8. The process of item 6 above, wherein the inorganic particle dispersion solution has a turbidity of not more than 50 ppm.

9. A process for manufacturing a recording medium for ink-jet recording, the process comprising the steps of:

1) supplying continuously at least inorganic particles and an aqueous medium to a first disperser;

2) dispersing inorganic particles in the first disperser to obtain a first inorganic particle dispersion solution;

3) ejecting continuously the first inorganic particle dispersion solution from the first disperser;

4) supplying continuously the ejected first dispersion solution to a second disperser;

5) dispersing the first dispersion solution in the second disperser to obtain a second inorganic particle dispersion solution;

6) ejecting continuously the second inorganic particle dispersion solution from the second disperser;

7) supplying continuously the ejected second dispersion solution to a third disperser;

8) dispersing the second dispersion solution in the third disperser to obtain a third inorganic particle dispersion solution;

9) ejecting continuously the third inorganic particle dispersion solution from the third disperser, wherein the steps 1), 2), 3), 4), 5), 6), 7), 8) and 9) are carried out at the first dispersion stage;

10) providing a coating solution containing the resulting inorganic particle dispersion solution; and

11) coating the coating solution on a support.

10. The process of item 9 above, wherein the first disperser, the second disperser and the third disperser are connected in series.

11. The process of item 9 above, wherein at least one of the first and second dispersers is a kneading disperser.

12. The process of item 11 above, wherein the kneading disperser has a rotor with a circumferential speed of 10 to 40 m/second.

13. The process of item 9 above, wherein the dwell time of the first dispersion solution in the first disperser and the dwell time of the second dispersion solution in the second disperser are each 0.1 to 600 seconds.

14. The process of item 9 above, wherein the third disperser is a pulverizing disperser.

15. The process of item 14 above, wherein the pulverizing disperser employs beads with a number average particle diameter of 0.2 to 2 mm as a dispersing medium.

16. The process of item 9 above, wherein the dwell time of the third dispersion solution in the third disperser is 1 to 30 minutes.

17. The process of item 9 above, wherein the second dispersion solution ejected from the second disperser has a turbidity of not more than 300 ppm.

18. The process of item 9 above, wherein the third dispersion ejected from the third disperser has a turbidity of not more than 50 ppm.

19. The process of item 9 above, wherein the inorganic particles are silica particles.

101. A process for manufacturing a recording medium for ink-jet recording, the process comprising the steps of:

1) supplying continuously at least inorganic particles and an aqueous medium to a disperser;

2) dispersing the inorganic particles in the disperser to obtain an inorganic particle dispersion solution;

3) ejecting continuously the inorganic particle dispersion solution from the disperser;

4) providing a coating solution containing the ejected inorganic particle dispersion solution; and

5) coating the coating solution on a support.

102. The process of item 101 above, wherein the disperser is a kneading disperser or a pulverizing disperser.

103. The process of item 101 or 102 above, wherein the inorganic particle dispersion solution has a turbidity of not more than 50 ppm.

104. The process of any one of items 101 through 103 above, wherein the dispersion solution contains a cationic resin.

105. The process of any one of items 101 through 104 above, wherein the inorganic particles are silica particles.

106. A process for manufacturing a recording medium for ink-jet recording, the method comprising the steps of:

1) supplying continuously at least inorganic particles and an aqueous medium to a first disperser;

2) dispersing the inorganic particles in the first disperser to obtain a first inorganic particle dispersion solution;

3) ejecting continuously the first inorganic particle dispersion solution from the first disperser;

4) supplying continuously the ejected first dispersion solution to a second disperser;

5) dispersing the first dispersion solution in the second disperser to obtain a second inorganic particle dispersion solution;

6) ejecting continuously the second inorganic particle dispersion solution from the second disperser;

7) providing a coating solution containing the ejected second inorganic particle dispersion solution; and

8) coating the coating solution on a support.

107. The process of item 106 above, wherein the first disperser and the second disperser are connected in series.

108. A process for manufacturing a recording medium for ink-jet recording, the process comprising the steps of:

1) supplying continuously at least inorganic particles and an aqueous medium to a first disperser;

2) dispersing the inorganic particles in the first disperser to obtain a first inorganic particle dispersion solution;

3) ejecting continuously the first inorganic particle dispersion solution from the first disperser;

4) supplying continuously the ejected first dispersion solution to a second disperser;

5) dispersing the first dispersion solution in the second disperser to obtain a second inorganic particle dispersion solution;

6) ejecting continuously the second inorganic particle dispersion solution from the second disperser;

7) supplying continuously the ejected second dispersion solution to a third disperser;

8) dispersing the second dispersion solution in the third disperser to obtain a third inorganic particle dispersion solution;

9) ejecting continuously the third inorganic particle dispersion solution from the third disperser;

10) providing a coating solution containing the ejected third inorganic particle dispersion solution; and

11) coating the coating solution on a support.

109. The process of item 108 above, wherein the first, second and third dispersers are connected in series.

110. The process of item 108 or 109 above, wherein at least one of the first and second dispersers is a kneading disperser.

111. The process of item 110 above, wherein the kneading disperser has a rotor capable of rotating at a circumferential speed of 10 to 40 m/second.

112. The process of any one of items 108 through 111 above, wherein the dwell time of the first dispersion solution in the first disperser and the dwell time of the second dispersion solution in the second disperser each are 0.1 to 600 seconds.

113. The process of any one of items 108 through 112 above, wherein the third disperser is a pulverizing disperser.

114. The process of items 113 above, wherein the pulverizing disperser employs beads with an average diameter of 0.2 to 2 mm as a dispersing medium.

115. The process of any one of item 108, 109 or 113 above, wherein the dwell time of the third dispersion solution in the third disperser is 1 to 30 minutes.

116. The process of any one of items 108 through 115 above, wherein the second dispersion solution has a turbidity of not more than 300 ppm.

117. The process of any one of items 108 through 116 above, wherein the third dispersion solution has a turbidity of not more than 50 ppm.

118. The process of any one of items 108 through 117 above, wherein the inorganic particles are silica particles.

Next, the present invention will be explained in detail.

In the invention, a dispersion process for preparing an inorganic particle dispersion solution (hereinafter referred to also as a dispersion solution) is not a process in which (a) the whole of inorganic particles and an aqueous medium to be dispersed is placed in a disperser (of batch type) and then dispersed therein for a certain period to obtain a dispersion solution, or (b) after an aqueous medium is placed in a disperser (of batch type), dispersion is carried out while adding inorganic particles to the batch type disperser to obtain a dispersion solution. The dispersion process in the invention of preparing an inorganic particle dispersion solution comprises the steps of 1) supplying continuously at least inorganic particles and an aqueous medium to a disperser, 2) dispersing the inorganic particles in the disperser to obtain an inorganic particle dispersion solution, and 3) ejecting continuously the resulting dispersion solution from the disperser, wherein the supplying, dispersing, and ejecting are carried out at the first dispersion stage. Herein, “the supplying, dispersing and ejecting are carried out at the first dispersion stage” implies that the supplying, dispersing and ejecting are first carried out in dispersion processes. In the invention, the dispersion process of 1) supplying continuously at least inorganic particles and an aqueous medium to a disperser, 2) dispersing the inorganic particles in the disperser to obtain a dispersion solution, and 3) ejecting continuously the resulting dispersion solution from the disperser is referred to as a continuous dispersion process, and a disperser capable of carrying out such a continuous dispersion process is referred to as a continuous disperser. In the invention, the continuous disperser is also referred to simply as a disperser, unless otherwise specified. The dispersion process, in which (a) the whole of inorganic particles and an aqueous medium to be dispersed is placed in a disperser (of batch type), and then dispersed therein for a certain period to obtain a dispersion solution, or (b) after an aqueous medium is placed in a disperser (of batch type), dispersion is carried out while adding inorganic particles to the batch type disperser to obtain a dispersion solution, is referred to as a batch type dispersion process, and such a batch type dispersion is carried out in a batch type disperser.

It is preferred in the invention that when inorganic particles and an aqueous medium are continuously supplied to a disperser at the first dispersion step, the inorganic particles in a certain amount (by weight or volume per unit time) and the aqueous medium in a certain amount (by weight or volume per unit time) each are continuously supplied in a certain amount ratio to the disperser, or a mixture of inorganic particles and an aqueous medium before dispersion is continuously supplied in a certain amount (by weight or volume per unit time) to the disperser.

In the invention, dispersion is carried out while supplying continuously the inorganic particles and the aqueous medium to a disperser, and therefore, materials for dispersion are continuously supplied to the disperser. According to this continuous supplying, after dispersion is carried out in the disperser for a certain period, the resulting dispersion solution is continuously ejected from the disperser. Therefore, the continuous supplying of the materials for dispersion necessarily results in the continuous ejecting of the dispersion products. In the invention, once the dispersion solution begins to be ejected, the supplying, dispersing and ejecting are continuously carried out until the supplying of materials for dispersion is stopped. In the invention, the process of preparing an inorganic particle dispersion solution comprises the step of dispersing inorganic particles in a disperser to obtain an inorganic particle dispersion solution in the first dispersion stage while supplying at least the inorganic particles and an aqueous medium to the disperser and while ejecting the resulting inorganic particle dispersion solution from the disperser.

The recording medium for ink-jet recording in the invention is obtained by coating inorganic particles on a support to form a coating layer (hereinafter referred to also as a void layer) comprising voids. The void layer is formed by coating a coating solution on a support. The dry thicknes of the void layer is preferably 20 to 80 μm, and more preferably 30 to 70 μm. The void rate of the void layer is preferably 40 to 80%, and more preferably 50 to 70%. Herein, the void rate is represented by the following formula: Void rate=(dry thickness of the void layer−dry thickness occupied by only solid in the void layer)×100/dry thickness of the void layer.

In the invention the coating solution comprises an inorganic particle dispersion solution. The aqueous medium used for preparation of the coating solution or the inorganic particle dispersion solution is comprised of mainly water, but may contain another solvent such as ethyl alcohol or ethyl acetate as long as dispersion is not jeopardized. The inorganic particles are dispersed in a dispersion solution, and dispersibility of the inorganic particles in the dispersion solution has an influence upon coating quality or product quality. Further, improvement of productivity depends on how efficiently the inorganic particle dispersion solution is prepared.

The present invention is to improve productivity of a dispersion solution, minimize coating defects, and improve product quality.

When the inorganic particle dispersion solution in the invention is prepared, it is preferred in view of production efficiency that inorganic particles and an aqueous medium each are supplied continuously in an intended supplying weight ratio to a disperser, and dispersed therein to obtain a dispersion solution. The sum of the supplying amount of the inorganic particles and aqueous medium is preferably 1.0 to 100 kg/minute, and more preferably 1.5 to 70 kg/minute. The inorganic particles and aqueous medium each are supplied continuously to the disperser to give an inorganic particle weight concentration in the dispersion solution of preferably 5 to 40%, and more preferably 10 to 35%. The weight concentration of inorganic particles is represented by the following formula:

Weight ratio=weight of inorganic particles×100/(weight of inorganic particles+weight of aqueous medium)

When inorganic particles and an aqueous medium in an intended weight ratio are supplied continuously to a disperser and dispersed therein, it is important that coagula are not formed in the dispersion solution, and a continuous disperser is employed as the disperser. It has been found that the use of a continuous kneading disperser (hereinafter also referred to simply as a kneading disperser) or a continuous pulverizing disperser (hereinafter also referred to simply as a pulverizing disperser) can provide a dispersion solution without forming coagula. It is preferred in view of high dispersion degree and production efficiency that after inorganic particles and an aqueous medium in an intended weight ratio have been dispersed in the kneading disperser or the pulverizing disperser to obtain a dispersion solution, the resulting dispersion solution is further dispersed in one or more of the succeeding kneading dispersers or the succeeding pulverizing dispersers.

The term, “coagula” herein referred to means large particles having a particle size of not less than 100 μm. Presence of coagula in the dispersion solution can be judged by touch, but in the invention, the presence is judged by magnifying the dispersion solution by a factor of 50 through an optical microscope and observing the magnified solution at 500 areas.

The kneading dispersers include dispersers of roller mill type, kneader type and pin mixer type. Examples of the kneading dispersers include KRC Kneader, KEX Extruder (produced by Kurimoto Tekko Co., Ltd.), Flow Jet Mixer (Funken Powtex Co., Ltd.) and Spiral Pin Mixer (produced by Taiheiyo Kiko Co., Ltd.).

The pulverizing dispersers include a high pressure homogenizer, a wet medium type pulverizer (a sand mill or a ball mill), a continuous high speed stirring disperser, and an ultrasonic disperser. Examples of the pulverizing dispersers include Mantongorin Homogenizer, Sonolater (Doei Shoji), Micro-Furuitizer (Mizuho Kogyo), Nanomizer (Tsukishima Kikai), Ultimizer (Itochu Sanki), Pearl Mill, Agitator Mill (Ashizawa), Grain Mill, Tornado (Asada Tekko), Visco Mill (Aimex), Mighty Mill, RS Mill, SG Mill (Inoue Seisakusho), Ebara Milder (Ebara Seisakusho), Fine Flow Mill, and Cabitron (Taiheiyo Kiko).

It has been found that that after inorganic particles and an aqueous medium in an intended weight ratio have been first dispersed in a continuous disperser to obtain a dispersion solution without coagula, the resulting dispersion solution may be incorporated in a batch type kneading disperser or a batch type pulverizing disperser, and then dispersed therein. Examples of the batch type kneading disperser or the batch type pulverizing disperser include Bannokongo Kakuhanki (produced by Dalton), Planetary Kneader Mixer (produced by Ashizawa), TK Highvisdispermix (produced by Tokushu Kika), Planetary Disper, AD Mill, Basket Mill (produced by Assda Tekko), EG Mill (produced by Inoue Seisakusho), and Clear Mix (produced by Emtechnique).

When a recording paper sheet for ink-jet recording is prepared employing an inorganic particle dispersion solution, the final dispersion degree of the dispersion solution has an influence upon coating quality or glossiness. However, product quality cannot be secured by controlling only the average particle diameter measured by an electron microscope or a particle size measuring apparatus. In order to minimize coating defects or improve quality such as glossiness, it is important to grasp whether or not large particles are present in the dispersion solution. It has been found that large particles are grasped by turbidity of the dispersion solution. However, a combination of turbidity and average particle diameter is preferably used in evaluation of dispersion degree. The number average particle diameter of the inorganic particles in the dispersion solution is preferably not more than 300 nm in view of glossiness, and more preferably 3 to 300 nm.

It has been found that the inorganic particle dispersion solution used in an ink-jet recording paper has a turbidity of preferably not more than 50 ppm, and more preferably 5 to 50 ppm.

In the invention, turbidity of the dispersion solution is measured by means of a turbidimeter, for example, an integrating sphere type turbidimeter, SEP-PT-706D produced by Mitsubisi Chemical Co., Ltd. In the measurement of turbidity, the dispersion solution is placed in a quartz cell with a width of 5 mm, and the turbidity is measured. In order to obtain a dispersion solution having a turbidity of not more than 50 ppm, a plurality of kneading dispersers or pulverizing dispersers as described above may be used, and they are preferably connected in series in view of production efficiency.

In order to supply an accurate amount of a dispersion solution ejected from a preceding disperser to a succeeding disperser in the dispersers connected in series, the dispersion solution may be supplied from the preceding disperser to the succeeding disperser employing a pump provided between the preceding disperser and the succeeding disperser, or the dispersion solution may be temporarily placed in a reservoir, and then supplied by a pump from the reservoir to the successive disperser.

A heat exchanger for controlling the temperature of the dispersion solution or a defoamer for defoaming the dispersion solution may be optionally provided between plural dispersers or on the exit side of the final disperser.

Temperature of the dispersion solution at dispersion is preferably 20 to 70° C. The aqueous medium is supplied to a first disperser in which dispersion is carried out first, and may be optionally supplied to the succeeding dispersers. The aqueous medium, which is optionally supplied to the succeeding dispersers, may be the same as or different from one supplied to the first disperser.

In order to obtain high productivity and dispersibility, preferably three dispersers, that is, a first disperser in which dispersion is carried out first, a second disperser following the first disperser, and a third disperser following the second disperser, are used, and more preferably, the three dispersers are connected in series. Still more preferably, all of the three dispersers are continuous dispersers (herein referred to as a complete continuous dispersion process). It is preferred that kneading or liquefaction is carried out in the first and second dispersers, and the resulting dispersion solution is dispersed in the third disperser to obtain a dispersion solution with an intended particle diameter and turbidity. Herein, the first and second dispersers function as preliminary dispersers, and the third disperser functions as the main disperser. Either the first or second disperser is preferably a kneading disperser, but the first disperser is more preferably a kneading disperser. The third disperser is preferably a pulverizing disperser.

Further, the following process can be also used. That is, the first and second dispersers are connected in series, and a plurality of third dispersers is connected in parallel on the output side of the second disperser. This form is a so-called batch type continuous dispersion process. In this case, the third dispersers are batch type pulverizing dispersers.

The kneading disperser is preferably of continuous type, and is preferably a disperser in which dispersion is carried out by rotating a rotor at a circumferential speed of 2 to 40 m/sec. A circumferential speed of less than 2 m/sec may produce coagula. A circumferential speed exceeding 40 m/sec tends to impose a burden on the disperser, and to result in wear of the disperser. Further, it generates high heat and may lower quality of the dispersion solution. The circumferential speed of the rotor is preferably 3 to 15 m/sec in view of wear of the disperser and heat generation.

The dwell time of the first dispersion solution in the first disperser and the dwell time of the second dispersion solution in the second disperser each are preferably 0.1 to 600 seconds. A dwell time of less than 0.1 seconds may lower dispersibility. A dwell time exceeding 600 seconds may generate high heat and lower the quality of the dispersion solution. The term, “dwell time” herein refers to time during which dispersion is carried out in one disperser, or the time from when materials to be dispersed are supplied to the one disperser and dispersed therein to obtain a dispersion solution till when the resulting dispersion solution is ejected from the disperser.

The third disperser as described above is preferably a pulverizing disperser with beads as a dispersing medium, and the beads have a number average bead particle diameter of preferably 0.2 to 2 mm. A diameter of less than 0.2 mm may be difficult to handle, and it is difficult to recover beads when the disperser is checked. Particularly, beads in narrow thread grooves are difficult to recover, and when the disperser with beads remaining in the thread grooves is screwed for sealing, the disperser may be damaged. A diameter exceeding 2 mm is easy to handle, but tends to require a longer dispersion time, and to result in lowering of productivity.

A dwell time of the third dispersion solution in the third disperser is preferably 1 to 30 minutes. A dwell time in the third disperser of less than 1 minute may lower dispersibility, while a dwell time exceeding 30 minutes may generate high heat and may lower the quality of the dispersion solution.

Materials of the vessel, rotor and beads used in the bead type pulverizing disperser can be selected in view of durability or cost. For example, when silica particles are used as inorganic particles, material of the vessel and rotor is preferably a resin, and especially preferably a urethane resin, and material of the beads is preferably zirconia.

It has been found that turbidity of the dispersion solution dispersed in the third disperser is preferably not more than 50 ppm in view of coatability and glossiness of the ink-jet recording medium, and turbidity of the dispersion solution dispersed in the second disperser is preferably not more than 300 ppm. A dispersion solution having a turbidity exceeding 300 ppm may contain coagula. Much time and much energy may be required to disperse such a solution in the third disperser to give a turbidity of less than 50 ppm, which may result in lowering of production efficiency.

Examples of the dispersion process used in the invention will be shown below, but the invention will be not limited thereto.

In the figures, disperser 1, disperser 2, and disperser 3 show a first disperser in which dispersion is first carried out, a second disperser which follows the first disperser and a third disperser which follows the second disperser, respectively.

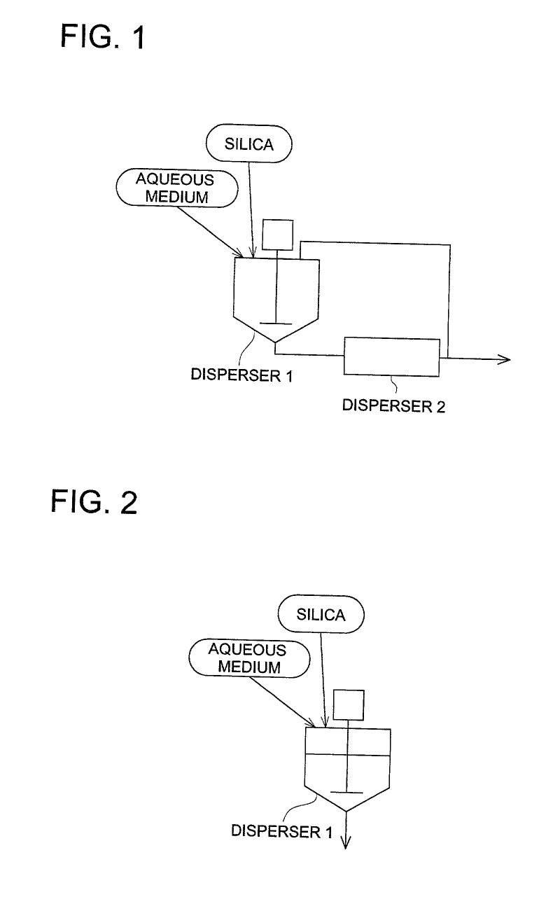

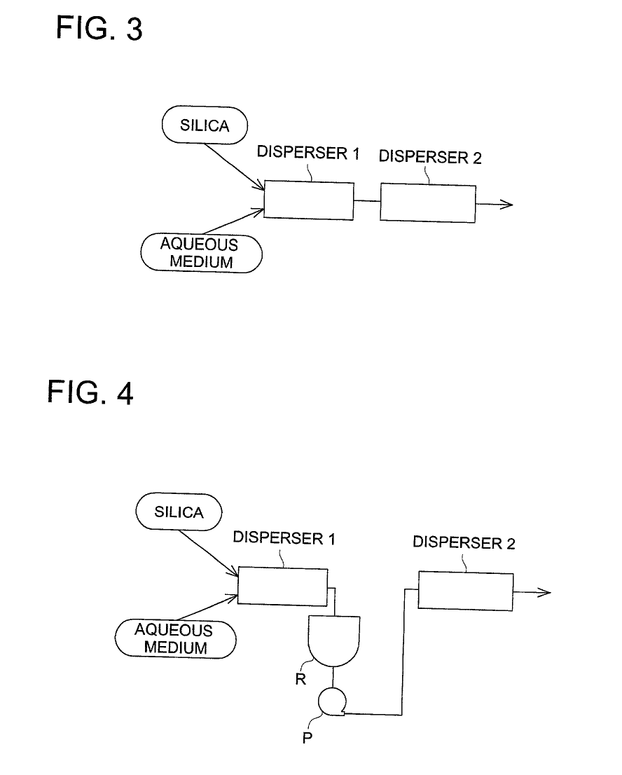

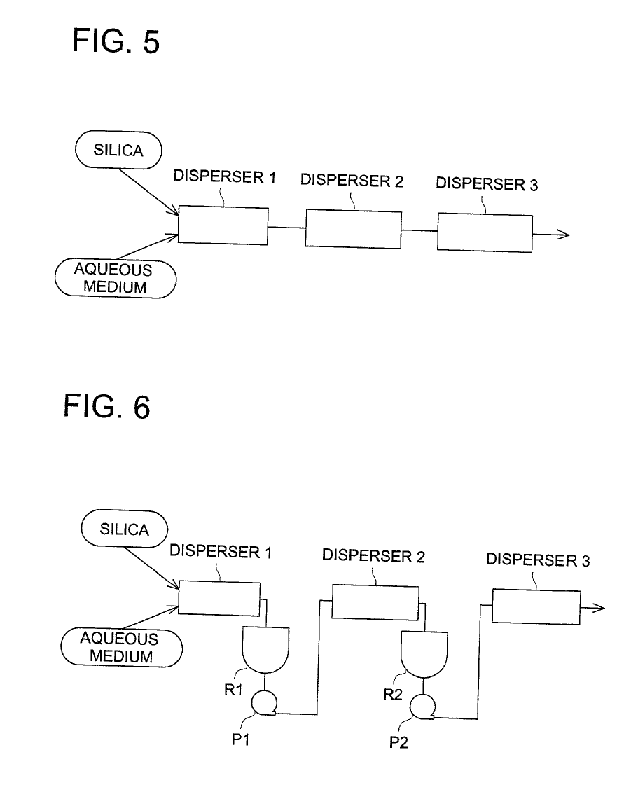

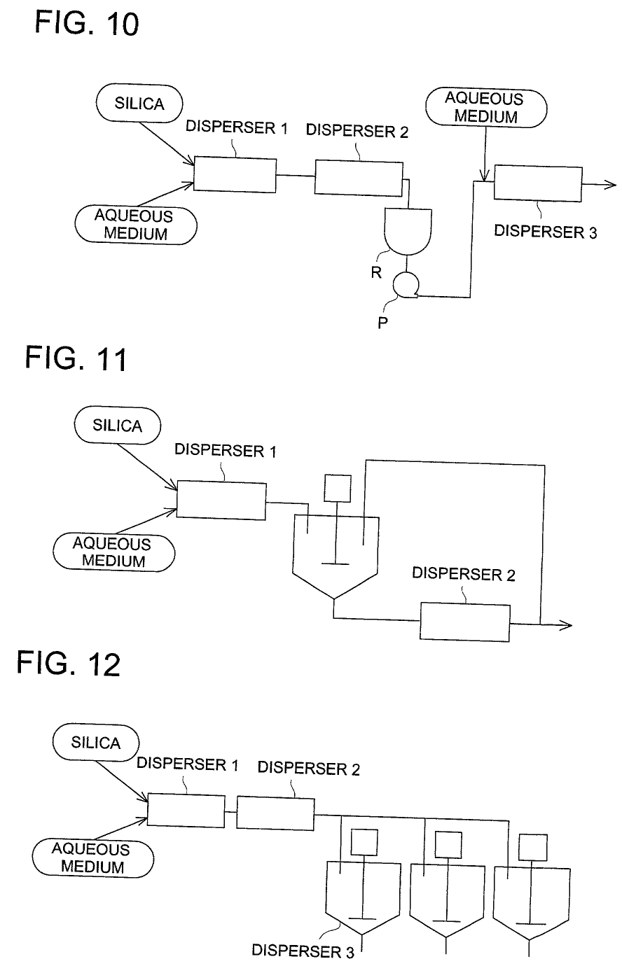

FIGS. 1 and 2 show conventional dispersion processes. In FIG. 1, silica particles and an aqueous medium are placed in a batch type disperser 1, then dispersed therein to obtain a first dispersion solution, and the resulting dispersion solution is supplied to a disperser 2 and further dispersed therein to obtain a second dispersion solution. Herein, the second dispersion solution dispersed in disperser 2 may be re-incorporated in the disperser 1 to repeat the above dispersion process. In FIG. 2, silica particles and an aqueous medium are placed in a batch type disperser 1, and then dispersed therein to obtain a final dispersion solution. FIGS. 3 through 13 show dispersion processes used in the invention. FIGS. 3, 4, 5, 6, 9 and 10 show complete continuous dispersion processes in which plural continuous dispersers are connected in series. FIGS. 4, 6 and 9 show dispersion processes in which a pump is provided between two adjacent dispersers of the plural continuous dispersers. In FIG. 3, two continuous dispersers 1 and 2 are connected in series. In FIG. 4, silica particles and an aqueous medium are continuously supplied to a disperser 1, and the resulting dispersion solution is continuously supplied to reservoir R, and then supplied from reservoir R to a disperser 2 by means of pump P. In FIG. 5, three continuous dispersers 1, 2, and 3 are connected in series. In FIG. 6, three continuous dispersers 1, 2 and 3 are connected in series, and reservoir R1 and pump P1 are provided between dispersers 1 and 2, and reservoir R2 and pump P2 between dispersers 2 and 3. In FIG. 9, three continuous dispersers 1, 2 and 3 are connected in series, and reservoir R and pump P are provided between dispersers 2 and 3. In FIG. 10, three continuous dispersers 1, 2 and 3 are connected in series, reservoir R and pump P being provided between dispersers 2 and 3. In FIG. 10, silica particles and an aqueous medium are continuously supplied to a disperser 1 to obtain a first dispersion solution, and the resulting dispersion solution is then supplied to a disperser 2, dispersed therein to obtain a second dispersion solution, and the second dispersion solution is supplied to reservoir R, and the second dispersion solution in reservoir R is supplied through pump P to a disperser 3 to which an aqueous medium is further added. FIG. 8 shows a complete continuous dispersion process in which a single continuous disperser is used.

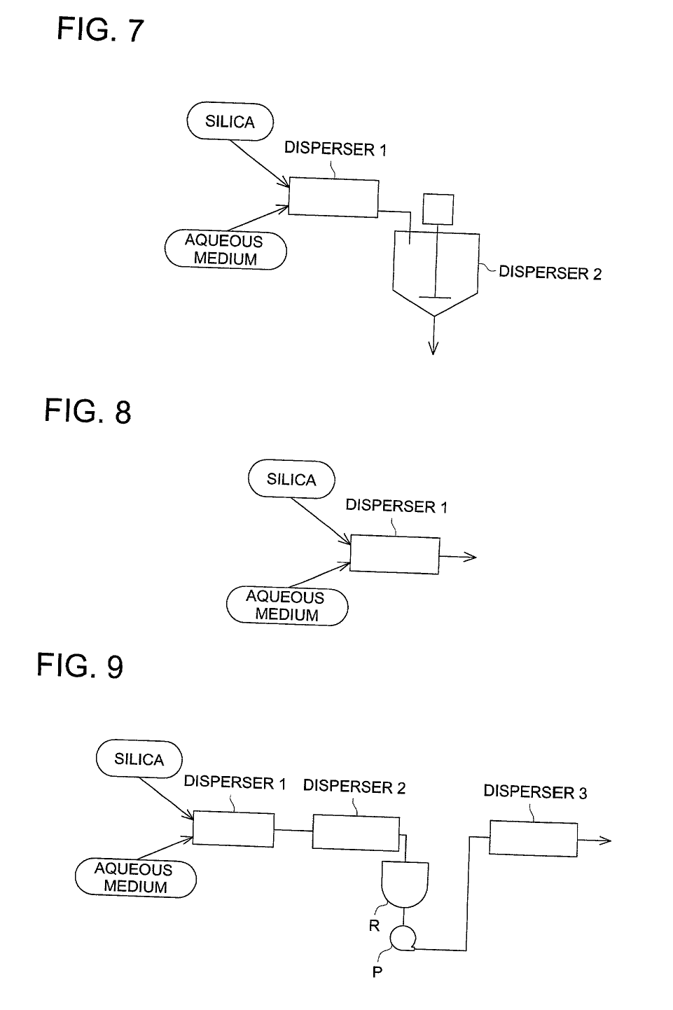

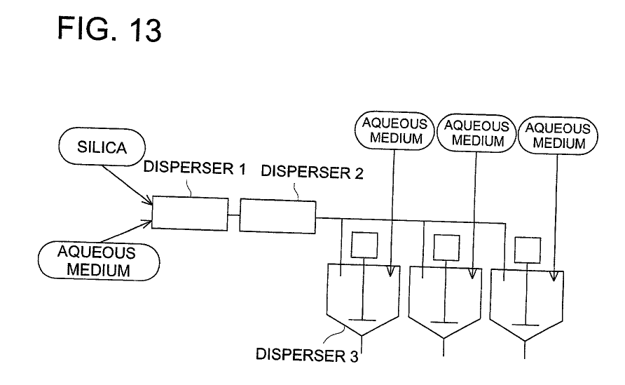

FIGS. 7, 12 and 13 show continuous dispersion processes comprising a batch type dispersion process in which dispersion is carried out in a batch disperser after the continuous dispersion process. In FIG. 7, silica particles and an aqueous medium are continuously supplied to a disperser 1, and the resulting dispersion solution is supplied to a batch type disperser 2 and dispersed therein to obtain a final dispersion solution. In FIG. 12, silica particles and an aqueous medium are continuously supplied to a disperser 1 to obtain a first dispersion solution, and the resulting dispersion solution is then supplied to a disperser 2, dispersed therein to obtain a second dispersion solution, and the second dispersion solution is supplied to one or more batch type dispersers 3 and dispersed therein to obtain a third dispersion solution. In FIG. 13, silica particles and an aqueous medium are continuously supplied to a disperser 1 to obtain a first dispersion solution, and the resulting dispersion solution is then supplied to a disperser 2, dispersed therein to obtain a second dispersion solution, and the second dispersion solution is supplied to one or more batch type dispersers 3, to which an aqueous medium is continuously supplied, and dispersed therein to obtain a third dispersion solution.

FIG. 11 shows a dispersion process in which dispersion is carried out in a batch type disperser after the continuous dispersion process, and after that, dispersion is carried out in a continuous disperser. In FIG. 11, silica particles and an aqueous medium are continuously supplied to a disperser 1 to obtain a first dispersion solution, and the resulting dispersion solution is supplied to a batch type disperser and dispersed therein, then supplied to a disperser 2 and dispersed therein to obtain a second dispersion solution. Further, the resulting second dispersion solution is re-incorporated to the batch type disperser, re-supplied to a disperser 2, and further dispersed therein, this process being repeated several times.

It is preferred that the coating solution in the invention contains a cationic polymer in view of resistance to water or ink absorption, or a hardener in view of layer strength. The coating solution optionally contains an additive other than the described above. The additive may be contained in the dispersion solution, and the cationic polymer or the hardener is preferably contained in the dispersion solution.

When plural dispersers are used, the additive can be dividedly supplied to each of the dispersers. Water can be supplied as an aqueous medium to succeeding dispersers in order to adjust the inorganic particle concentration of the dispersion solution.

Examples of the inorganic particles include various natural or synthetic inorganic particles such as particles of silica, calcium carbonate, titanium oxide, aluminum hydroxide, magnesium carbonate, zinc oxide, barium sulfate, and clay.

Among these, silica particles are preferably used on account of the low refractive index to form an ink receiving layer (hereinafter referred to also as a void layer) of a recording medium for ink-jet recording in which transparency is required.

As the silica, silica synthesized by a conventional wet method, colloidal silica, or silica fine particles synthesized by a gas phase method are preferably used, and colloidal silica, or silica fine particles synthesized by a gas phase method is more preferably used. The silica fine particles synthesized by a gas phase method is most preferable in that they provide a high void content, and are difficult to form large aggregates particularly when used in combination with cationic polymers.

The number average primary order particle diameter of the inorganic particles is preferably 3 to 100 nm, more preferably 4 to 50 nm, and most preferably 4 to 20 nm.

As silica fine particles synthesized by a gas phase method having a number average primary order particle diameter of 4 to 20 nm, which are most preferably used, there is, for example, Aerosil, which is available on the market and produced by Nihon Aerosil Co.

A cationic polymer is preferably contained in the inorganic particle dispersion solution.

A cationic polymer has been so far dispersed in an inorganic particle dispersion solution in a batch type disperser. However, when anionic inorganic particles such as the above silica particles are mixed with the cationic polymer in a batch type disperser, aggregation occurs, resulting in coagula. Even if vigorously stirred, much time and much energy are required to obtain a dispersion solution free from coagula in the batch type disperser. The present invention also solves the problems as described above by dispersing the inorganic particles and the cationic polymer in the intended weight ratio in a continuous kneading disperser or a continuous pulverizing disperser.

The cationic polymer is preferably a polymer having a quaternary ammonium group, and more preferably a homopolymer of a monomer having a quaternary ammonium group or a copolymer of a monomer having a quaternary ammonium group and one or two more of other monomers capable of copolymerizing with the monomer having a quaternary ammonium group.

Examples of the monomer having a quaternary ammonium group will be shown below.

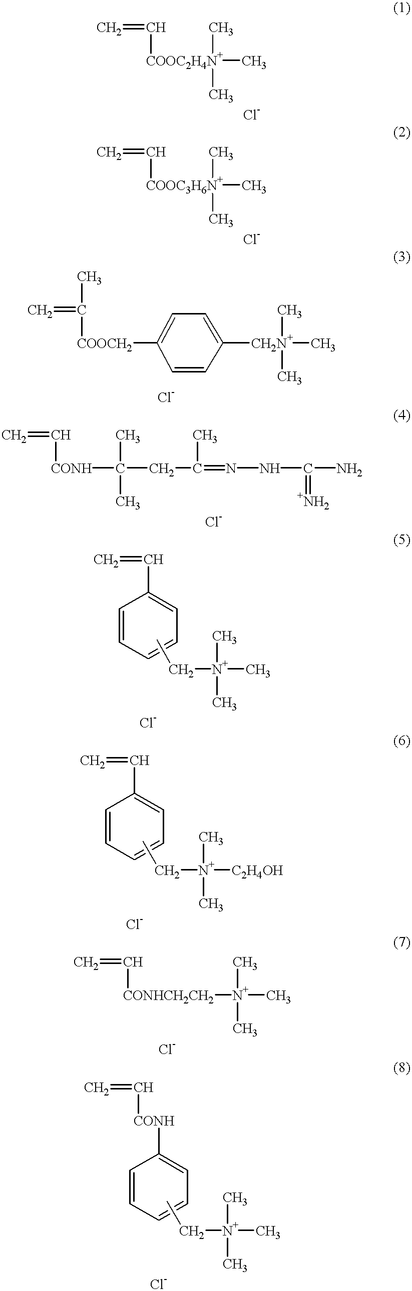

The monomer capable of copolymerizing with the monomer having a quaternary ammonium group is a monomer having an ethylenically unsaturated group, and examples thereof will be shown below.

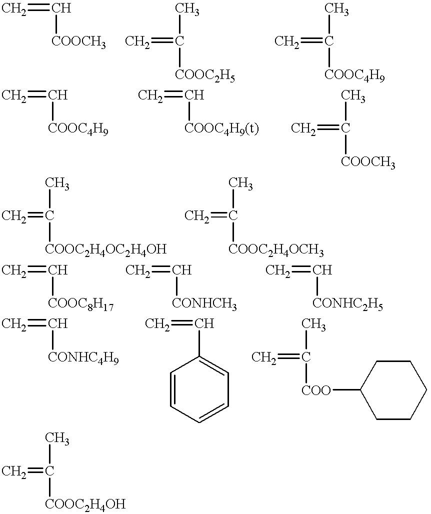

When a cationic polymer having a quaternary ammonium group is a copolymer, the content of the cationic monomer in the cationic polymer is preferably not less than 10 mol %, more preferably not less than 20 mol %, and most preferably not less than 30 mol %.

The monomer having a quaternary ammonium group in the cationic polymer may be one or more kinds thereof.

Examples of the cationic polymer will be shown below, but the invention is not limited thereto.

| | | |
|---|---|---|
| P-1 | [chemical structure] | Mn = 20,000 |
| P-2 | 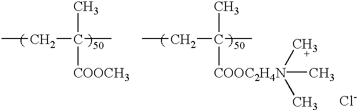 | Mn = 25,000 |
| P-3 | 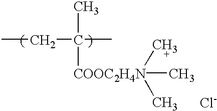 | Mn = 50,000 |
| P-4 | 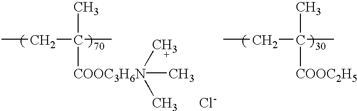 | Mn = 63,000 |
| P-5 | 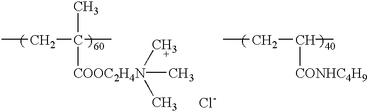 | Mn = 19,000 |
| P-6 | 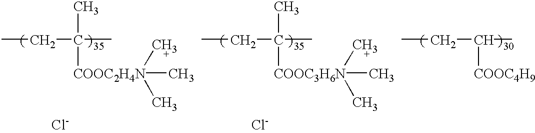 | Mn = 72,000 |
| P-7 | 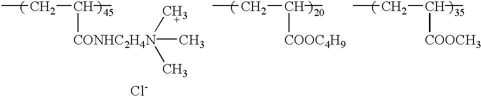 | Mn = 22,000 |
| P-8 | 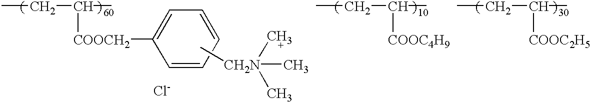 | Mn = 46,000 |
| P-9 | 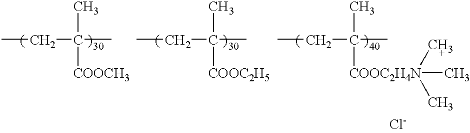 | Mn = 16,000 |
| P-10 | 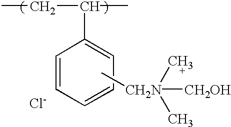 | Mn = 36,000 |
| P-11 | 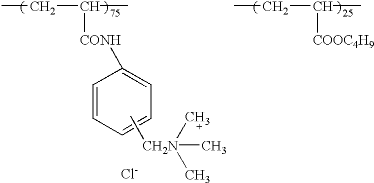 | Mn = 56,000 |
| P-12 | 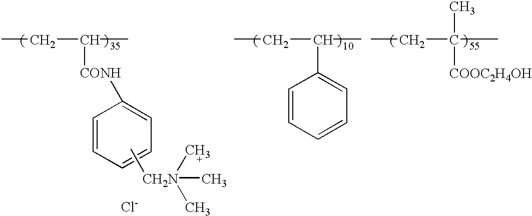 | Mn = 32,000 |
| P-13 | 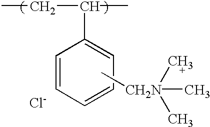 | Mn = 24,000 |
| P-14 | 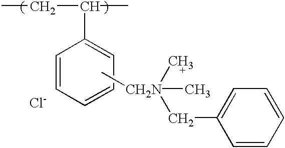 | Mn = 19,000 |
| P-15 | 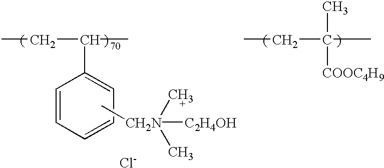 | Mn = 48,000 |
| P-16 | 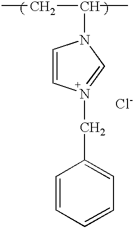 | Mn = 71,000 |
| P-17 | 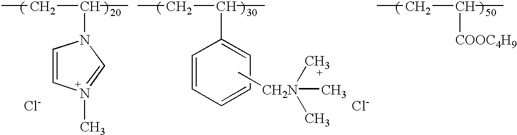 | Mn = 63,000 |

The cationic polymer having a quaternary ammonium group generally has a high water solubility due to its quaternary ammonium group, but may be a copolymer which is not sufficiently soluble in water, depending on the content ratio of a monomer not having a quaternary ammonium group in the copolymer. However, any polymer having a quaternary ammonium group can be used in the invention, as long as it is soluble in a mixture solvent of water and a water-miscible organic solvent.

The water-miscible organic solvents include alcohols such as methanol, ethanol, isopropanol and n-propanol, glycols such as ethylene glycol, diethylene glycol, and glycerin, esters such as ethyl acetate, and propyl acetate, ketones such as acetone, and methyl ethyl ketone, and amides such as N,N-dimethylformamide, and are organic solvents having a water solubility of not less than 10% by weight based on weight of water. The amount used of the water-miscible organic solvents is preferably not more than that of water.

The cationic polymer in the invention has a number average molecular weight of preferably not more than 100,000.

Herein, the number average molecular weight is a value in terms of polyethylene glycol obtained according to a gel permeation chromatography method.

When a solution containing a cationic polymer having a number average molecular weight exceeding 100,000 is mixed with a dispersion solution containing inorganic particles whose surface is anionic, aggregates may be produced. Such a mixture dispersion solution is difficult to be uniformly dispersed, even if subjected to further dispersing treatment, and large particles are difficult to be eliminated from the dispersion solution. When a recording paper sheet is prepared employing such a dispersion solution containing such a cationic polymer and such inorganic particles, high glossiness is difficult to be obtained. The cationic polymer has a number average molecular weight of especially preferably not more than 50,000.

The lower limit of the number average molecular weight of the cationic polymer is preferably not less than 2000 in view of water resistance of colorants in ink. The content ratio of the inorganic particles to the cationic polymer varies due to kinds or particle size of the particles or kinds or the number average molecular weight of the polymer.

The above ratio is preferably 1:0.01 to 1:1 by weight, since the inorganic particles are required to be stabilized by making cationic the surface of the inorganic particles.

Various kinds of additives may be added to the dispersion solution.

Examples of such additives include various kinds of nonionic or cationic surfactants (anionic surfactants are not preferable, since aggregates are formed), a defoaming agent, nonionic hydrophilic polymers (for example, polyvinyl alcohol, polyvinyl pyrrolidone, polyethylene oxide, polyacrylamide, various kinds of saccharides, gelatin, or pullulan), nonionic or cationic latexes, water-miscible organic solvents (for example, ethyl acetate, methanol, ethanol, isopropanol, n-propanol, or acetone), inorganic salts, and a pH adjusting agent. They can be optionally used.

Particularly, use of the water-miscible organic solvents is preferable in that when the inorganic particles and cationic polymer are mixed, small coagula are difficult to form. The water-miscible organic solvent content of the dispersion solution is preferably 0.1 to 20% by weight, and more preferably 0.5 to 10% by weight.

The pH of the cationic dispersion solution varies due to kinds of inorganic particles, cationic polymers, or additives, but it is preferably 1 to 8, and more preferably 2 to 7.

A hydrophilic polymer is preferably added to the dispersion solution as a binder.

The hydrophilic polymers used in the invention include gelatin (preferably acid-processed gelatin), polyvinyl pyrrolidone (having a weight average molecular weight of preferably 200,000 or more), pullulan, polyvinyl alcohol or its derivative, cation-modified polyvinyl alcohol, polyethylene glycol (having a weight average molecular weight of preferably 100,000 or more), hydroxyethyl cellulose, dextrane, dextrin and a hydrophilic polyvinyl butyral. These hydrophilic binders may be used singly or in combination.

The preferred hydrophilic binder is polyvinyl alcohol or cation-modified polyvinyl alcohol.

The polyvinyl alcohol used in the invention has an average polymerization degree of preferably 300 to 4,000. Polyvinyl alcohol having a weight average molecular weight of not less than 1000 is especially preferable in view of layer strength.

The polyvinyl alcohol has a saponification degree of preferably 70 to 100 mol %, and more preferably 80 to 100 mol %.

The cation-modified polyvinyl alcohol is obtained by saponifying a copolymer of vinyl acetate and an ethylenically unsaturated monomer having a cationic group.

Examples of the ethylenically unsaturated monomer having a cationic group include trimethyl-(2-acrylamide-2,2-dimethylethyl)ammonium chloride, trimethyl-(3-acrylamide-3,3-dimethylpropyl)ammonium chloride, N-vinylimidazole, N-vinyl-2-methylimidazole, N-(3-dimethylaminopropyl)methacrylamide, hydroxyethyldimethyl(3-methacrylamide)ammonium chloride, trimethyl-(3-methacrylamidopropyl)ammonium chloride, and N-(1,1-dimethyl-3-dimethylaminopropyl)acrylamide.

The content of the monomer having a cationic group in the cation-modified polyvinyl alcohol is preferably 0.1 to 10 mol %, more preferably 0.2 to 5 mol %, based on the vinyl acetate content.

The cation-modified polyvinyl alcohol has a polymerization degree of ordinarily 500 to 4,000, preferably 1,000 to 4,000.

The saponification degree of the cation-modified polyvinyl alcohol is ordinarily 60 to 100 mol %, and preferably 70 to 99 mol %.

It is preferable in the invention that silica particles in primary order particle form and polyvinyl alcohol or modified polyvinyl alcohol as a hydrophilic binder are used, wherein a weak hydrogen bond is formed between a silanol group on the silica surface and a hydroxy group of the polyvinyl alcohol to form a flocculate, resulting in high void content.

The content ratio by weight of the hydrophilic binder to the inorganic particles is preferably 1:10 to 1:3, and more preferably 1:8 to 1:5.

The methods of adding the above-described hydrophilic polymer as a binder to the dispersion solution include a method of adding a solution of the hydrophilic polymer to the dispersion solution in a batch while stirring, and a method of mixing continuously the dispersion solution with the hydrophilic polymer in a mixer such as a static mixer. The latter method is preferable in view of a space occupied by an apparatus used or production efficiency.

When the hydrophilic polymer is added, a high molecular weight hydrophilic polymer is preferably added to the dispersion solution to which a small amount of a low molecular weight hydrophilic polymer has been added in advance, since coagulation or viscosity increase is difficult to occur, and a stable coating solution and a stable coating layer without cracks are obtained.

The weight average molecular weight of the low molecular weight hydrophilic polymer is ordinarily 2000 to 50,000, and preferably 3,000 to 40,000. The content ratio by weight of the low molecular weight hydrophilic polymer to the hydrophilic polymer in the dispersion solution is ordinarily 0.001 to 0.2, and preferably 0.002 to 0.1.

The low molecular weight hydrophilic polymer is preferably polyvinyl alcohol having a polymerization degree of 300 to 600.

The additives as described above include a hardener. The hardener is generally a compound having a group capable of reacting with the hydrophilic polymer or a compound capable of accelerating reaction between the different groups which the hydrophilic polymer has. The hardeners are selected depending upon kinds of hydrophilic polymers used.

Examples of the hardeners include epoxy type hardeners (for example, diglycidylethyl ether, ethylene glycol diglycidyl ether, 1,4-butanediol diglycidyl ether, 1,6-diglycidylcyclohexane, N,N-diglycidyl-4-glycidyloxyaniline, sorbitol polyglycidyl ether, glycerol polyglycidyl ether), aldehyde type hardeners (for example, formaldehyde, glyoxal), active halogen type hardeners (for example, 2,4-dichloro-4-hydroxy-1,3,5-s-triazine), active vinyl type hardeners (for example, 1,3,5-trisacryloyl-hexahydro-s-triazine, bisvinylsulfonylmethyl ether), boric acid or its salt, borax, and alum.

When polyvinyl alcohol or cation-modified polyvinyl alcohol is used as the hydrophilic polymer, boric acid or its salt or epoxy type hardeners are preferably used as a hardener.

The most preferable hardener is boric acid or its salt.

The boric acid or its salt is an oxygen acid of boron or its salt, and the examples thereof include orthoboric acid, diboric acid, metaboric acid, tetraboric acid, pentaboric acid, octaboric acid and their salts.

The amount used of the hardeners is varied depending on kinds of binders used, kinds of hardeners used, kinds of fine inorganic particles or the content ratio of the inorganic particles to hydrophilic polymers used, but it is ordinarily 5 to 500 mg, and preferably 10 to 300 mg per g of hydrophilic polymers used.

The hardeners may be added to a void layer coating solution or a coating solution for forming another layer adjacent to the void layer at the time when the void layer coating solution is coated. The void layer coating solution may be coated on a hardener-containing layer provided on a support, or after a void layer coating solution containing no hardener is coated on a support and dried, a hardener-containing solution may be then coated on the dried layer to form a hardener-containing void layer. It is preferred in view of production efficiency that the hardener is added to a void layer coating solution or a coating solution for forming a layer adjacent to the void layer, wherein the hardener is supplied to a void layer to be formed at the time when the void layer or the layer adjacent to the void layer is coated on a support.

In the preferable method of forming a void layer, which contains polyvinyl alcohol and super fine silica particles synthesized according to a gas phase method, a hardener is added to a void layer coating solution, allowed to stand for a specific time (preferably 10 minutes or more, and more preferably 30 minutes or more), coated on a support, and dried to form a void layer having a higher void rate with no layer strength deterioration.

When the cationic fine particle dispersion solution is prepared, the hardener can be added in advance as an additive.

The additives other than the described above include polystyrene, polyacrylates, polymethacrylates, polyacrylamides, polyethylene, polypropylene, polyvinyl chloride, polyvinylidene chloride, or their copolymers, organic latexes such as a urea resin and a melamine resin, oil drops such as liquid paraffin, dioctyl phthalate, tricresyl phosphate and silicone oil, various surfactants such as cationic and nonionic surfactants, a UV absorbent disclosed in Japanese Patent O.P.I. Publication Nos. 57-74193, 57-87988 and 62-261476, an anti-fading agent disclosed in Japanese Patent O.P.I. Publication Nos. 57-74192, 57-87989, 60-72785, 61-146591, 1-95091 and 3-13376, a fluorescent brightening agent, a pH adjusting agent such as sulfuric acid, phosphoric acid, citric acid, sodium hydroxide, potassium hydroxide or potassium carbonate, an anti-foaming agent, an anti-septic agent, a thickner, an anti-static agent and a matting agent disclosed in Japanese Patent O.P.I. Publication Nos. 59-42993, 59-52689, 62-280069, 61-24287 and 4-219266.

Supports used in the ink-jet recording medium in the invention include well-known, conventional supports for an ink-jet recording medium such as paper sheet supports, plastic sheet supports (transparent), and composite sheet supports. The support is preferably a hydrophobic support into which ink does not permeate in that an image with sharpness and high density is obtained.

The examples of the transparent support in the invention include a resin film comprised of a polyester resin, a diacetate resin, a triacetate resin, an acryl resin, a polycarbonate resin, a polyvinyl chloride resin, a polyimide resin, cellophane or celluloid. The support is preferably a heat resistant film, when used for an over-head projector, and especially preferably a polyethylene terephthalate film. The thickness of the transparent support is preferably 10 to 200 μm. A subbing layer is preferably provided on an ink-receiving layer side of a support or on a backing layer side of the support opposite the ink-receiving layer in view of adhesion of the ink-receiving layer or the backing layer to the support.

A translucent support, which may be used, is preferably a resin-coat paper (so-called RC paper) in which a polyolefin resin containing white pigment is provided on at least one surface of a base paper sheet or a polyethylene terephthalate sheet (so-called white PET) containing white pigment.

A method of coating a coating layer on a support can be selected from conventional ones. The preferable method is a method in which a coating solution is coated on a support and dried to formed a layer. The two or more layers can be simultaneously coated, and especially preferably, all the hydrophilic layers are simultaneously coated.

The coating methods include a roller coating method, a rod-bar coating method, an air-knife coating method, a spray coating method, a curtain coating method and an extrusion coating method using a hopper disclosed in U.S. Pat. No. 2,681,294.

### EXAMPLES

The invention will be detailed according to the following examples, but is not limited thereto. In the examples, the term “L” in the examples is liter, and the term “an average particle diameter” is a number average particle diameter.

### Example 1

Aqueous medium (hereinafter referred to as solution A)

| | | |
|---|---|---|
| Water | 80 | L |
| Boric acid | 0.27 | kg |
| Borax | 0.23 | kg |
| 5% Nitric acid solution | 0.4 | L |
| Ethanol | 1.3 | L |
| Aqueous 25% by weight P-9 solution | 17 | L |

The above composition was mixed to obtain solution A. As inorganic particles were prepared 32 kg of silica particles with a number average primary order particle diameter of 7 nm (A300 produced by Nihon Aerosil Co., hereinafter referred to as A300), which were synthesized according to a gas phase method.

Dispersion solution 1 was prepared according to the process as shown in FIG. 9. To disperser 1, a spiral pin mixer SPM25W (produced by Taiheiyo Kiko Co., hereinafter referred to as SPM) were supplied solution A at a rate of 1.56 kg/min and A300 at a rate of 0.44 kg/min to give a first dispersion solution. The resulting first dispersion solution was ejected from disperser 1 and supplied to disperser 2, SPM to give a second dispersion solution. The second dispersion solution was ejected from disperser 2 and supplied at a rate of 2.0 kg/min, employing a mono pump, to disperser 3, LMK-4 (a continuous pulverizing disperser of a wet medium type, produced by Ashizawa Co., hereinafter referred to as LMK). In SMP, dispersion was carried out under conditions of a circumferential speed of 36 m/sec and a dwell time of 30 seconds. In LMK, whose vessel and rotor were made of urethane resin, dispersion was carried out, employing zirconia beads having a number average bead diameter of 0.5 mm, under conditions of a rotor circumferential speed of 8 m/sec and a dwell time of 2 minutes. Thus, dispersion solution 1 was obtained.

The second dispersion solution ejected from disperser 2 had a turbidity of 52 ppm and dispersion particles with a number average particle diameter of 59 nm. Dispersion solution 1 ejected from disperser 3 had a turbidity of 18 ppm and dispersion particles with a number average particle diameter of 53 nm. Turbidity of the dispersion solution was measured by means of an integrating sphere type turbidimeter, SEP-PT-706D produced by Mitsubisi Chemical Co., Ltd. In the measurement of turbidity, the dispersion solution is placed in a quartz cell with a width of 5 mm, and the turbidity was measured. The number average particle diameter was obtained as an average of measurements of particle diameters of one thousand particles magnified by a factor of 20,000 by means of an electron microscope.

### Example 2

Dispersion solution 2 was prepared in the same manner as in Example 1 above, except that the circumferential speed of SPM was changed to 11 m/sec. The second dispersion solution ejected from disperser 2 had a turbidity of 290 ppm and dispersion particles with a number average particle diameter of 70 nm. Dispersion solution 2 ejected from disperser 3 had a turbidity of 50 ppm and dispersion particles with a number average particle diameter of 60 nm.

### Example 3

Dispersion solution 3 was prepared in the same manner as in Example 1 above, except that in LMK, the number average bead diameter of the beads was changed to 2 mm, and the dwell time to 20 minutes. The dwell time in LMK was changed adjusting an amount of the dispersion solution supplied to LKM.

Dispersion solution 3 had a turbidity of 48 ppm and dispersion particles with a number average particle diameter of 56 nm.

### Example 4

Dispersion solution 4 was prepared in the same manner as in Example 3 above, except that in LMK, the number average bead diameter of the beads was changed to 0.5 mm.

Dispersion solution 4 had a turbidity of 17 ppm and dispersion particles with a number average particle diameter of 51 nm.

### Example 5

Dispersion solution 5 was prepared in the same manner as in Example 1 above, except that disperser 2 was changed to Fine Flow Mill FM-25 (a continuous high speed stirring type disperser, produced by Taiheiyo Kiko Co., hereinafter referred to simply as FM). In FM, the circumferential speed was 25 m/sec and the dwell time was 0.15 seconds.

Herein, the second dispersion solution ejected from disperser 2 had a turbidity of 40 ppm and dispersion particles with a number average particle diameter of 55 nm, and was designated as dispersion solution 5-a, which corresponded to a dispersion solution according to the process as shown in FIG. 3. Dispersion solution 5 had a turbidity of 16 ppm and dispersion particles with a number average particle diameter of 53 nm.

### Example 6

Dispersion solution 6 was prepared in the same manner as in Example 1 above, except that disperser 1 was changed to KRC KNEADER S5TYPE (produced by Kurimoto Tekko Co., hereinafter referred to as KRC). In KRC, the circumferential speed was 2 m/sec and the dwell time was 540 seconds.

The second dispersion solution ejected from disperser 2 had a turbidity of 50 ppm and dispersion particles with a number average particle diameter of 60 nm. Dispersion solution 6 had a turbidity of 16 ppm and dispersion particles with a number average particle diameter of 55 nm.

### Example 7

Dispersion solution 7 was prepared in the same manner as in Example 5 above, except that the circumferential speed of disperser 1, SPM was changed to 25 m/sec.

The second dispersion solution ejected from disperser 2 had a turbidity of 49 ppm and dispersion particles with a number average particle diameter of 55 nm. Dispersion solution 7 had a turbidity of 17 ppm and dispersion particles with a number average particle diameter of 54 nm.

### Example 8

Dispersion solution 8 was prepared in the same manner as in Example 5 above, except that disperser 1 was changed to FLOW JET MIXER 300TYPE (a pin mixer type, produced by Funken Powtex Co., hereinafter referred to simply as FJM), and in FJM, the circumferential speed was 25 m/sec and the dwell time was 20 seconds.

The second dispersion solution ejected from disperser 2 had a turbidity of 48 ppm and dispersion particles with a number average particle diameter of 55 nm. Dispersion solution 8 had a turbidity of 10 ppm and dispersion particles with a number average particle diameter of 51 nm.

### Example 9

Dispersion solution 9 was prepared according to the process as shown in FIG. 10. Dispersion solution 9 was prepared in the same manner as in Example 1 above, except that dispersers 1 and 2 were changed to FJM, in which the circumferential speed was changed to 25 m/sec, and the dwell time was changed to 20 seconds, water in an amount of 0.9 kg/min was further supplied, together with the second dispersion solution ejected from disperser 2, to disperser 3 LMK, in which the dwell time was changed to 1.4 minutes.

The second dispersion solution ejected from disperser 2 had a turbidity of 49 ppm and dispersion particles with a number average particle diameter of 55 nm. Dispersion solution 9 had a turbidity of 15 ppm and dispersion particles with a number average particle diameter of 52 nm.

### Example 10

Dispersion was carried out according to the process as shown in FIG. 7. As disperser 1, FJM was used in which the circumferential speed was 1 m/sec, and the dwell time was 30 seconds. As disperser 2, a batch type disperser, an open batch type bead mill was used in which the beads used were zirconia beads having a number average bead diameter of 0.5 mm, the dispersion solution to beads ratio was 1:1 by volume (50 L of each were used), the circumferential speed was 8 m/sec, and the dispersion time was 25 minutes. The aqueous medium used, inorganic particles used, and their rates supplied to FJM were the same as those in Example 1. Thus, dispersion solution 10 was obtained. Dispersion solution 10 had a turbidity of 60 ppm and dispersion particles with a number average particle diameter of 60 nm.

### Example 11

Dispersion was carried out according to the process as shown in FIG. 12. As dispersers 1 and 2, FJM was used in which the circumferential speed was 11 m/sec, and the dwell time was 30 seconds. As disperser 3, one open batch type bead mill was used in which the beads used were zirconia beads having a number average bead diameter of 0.5 mm, 50 L of each of the dispersion solution and beads were employed (that is, the dispersion solution to beads ratio was 1:1 by volume), the circumferential speed of the rotor was 8 m/sec, and the dispersion time was 2 minutes. The aqueous medium used, inorganic particles used, and their rates supplied to disperser 1, FJM were the same as those in Example 1. Thus, dispersion solution 11 was obtained.

The second dispersion solution ejected from disperser 2 had a turbidity of 200 ppm and dispersion particles with a number average particle diameter of 68 nm. Dispersion solution 11 had a turbidity of 30 ppm and dispersion particles with a number average particle diameter of 54 nm.

### Example 12

Dispersion solution 12 was prepared in the same manner as in Example 11 above, except that the circumferential speed of FJM was 25 m/sec.

The second dispersion solution ejected from disperser 2 had a turbidity of 49 ppm and dispersion particles with a number average particle diameter of 54 nm. Dispersion solution 12 had a turbidity of 10 ppm and dispersion particles with a number average particle diameter of 50 nm.

### Example 13

Dispersion was carried out according to the process as shown in FIG. 13. As dispersers 1 and 2, FJM was used in which the circumferential speed was 25 m/sec, and the dwell time was 30 seconds. As disperser 3, an open batch type bead mill was used in which the beads used were zirconia beads having a number average bead diameter of 0.5 mm. Solution A at a rate of 1.56 kg/min and A300 at a rate of 0.44 kg/min were supplied to disperser 1 in the same manner as in Example 1. Fifty liters of the second dispersion solution ejected from disperser 2 were introduced in the batch type bead mill containing 50 L of beads, and 2.5 L of water were added in one minute while rotating the rotor at a circumferential speed of 8 m/sec, and further dispersed for one minute to obtain dispersion solution 13. The second dispersion solution ejected from disperser 2 had a turbidity of 49 ppm and dispersion particles with a number average particle diameter of 53 nm. Dispersion solution 13 had a turbidity of 13 ppm and dispersion particles with a number average particle diameter of 52 nm.

### Example 14

Dispersion solution 14 was prepared in the same manner as in Example 9 above, except that in solution A, 17 L of the P-9 solution were replaced with 10 L of an aqueous 25 weight % P-10 solution and 80 L of water with 87 L of water. Dispersion solution 14 had a turbidity of 17 ppm and dispersion particles with a number average particle diameter of 50 nm.

### Example 15

Dispersion solution 15 was prepared in the same manner as in Example 9 above, except that in solution A, 0.27 kg of boric acid and 0.23 kg of borax were replaced with 0.5 kg of water. Dispersion solution 15 had a turbidity of 14 ppm and dispersion particles with a number average particle diameter of 49 nm.

### Example 16

Dispersion solution 16 was prepared in the same manner as in Example 9 above, except that in solution A, 17 L of the P-9 solution were replaced with 17 L of water. Dispersion solution 16 had a turbidity of 18 ppm and dispersion particles with a number average particle diameter of 52 nm.

### Example 17

Dispersion solution 17 was prepared in the same manner as in Example 8 above, except that solution A was supplied to disperser 1 at a rate of 1.3 kg/min, and A300 at a rate of 0.7 kg/min.

Dispersion solution 17 had a turbidity of 10 ppm and dispersion particles with a number average particle diameter of 48 nm.

### Example 18

Dispersion solution 18 was prepared in the same manner as in Example 8 above, except that solution A was supplied to disperser 1 at a rate of 1.8 kg/min, and A300 at a rate of 0.2 kg/min.

Dispersion solution 18 had a turbidity of 45 ppm and dispersion particles with a number average particle diameter of 53 nm.

### Example 19

Dispersion solution 19 was prepared in the same manner as in Example 8 above, except that A300 was replaced with silica synthesized according to a wet process (Nipsil. HD-2: a number average primary order particle diameter of 11 nm, produced by Nihon Silica Kogyo Co., Ltd.).

Dispersion solution 19 had a turbidity of 30 ppm and dispersion particles with a number average particle diameter of 60 nm.

### Example 20

Dispersion solution 20 was prepared in the same manner as in Example 10 above, except that the batch type disperser 2 was changed to a batch type high speed stirring disperser, CLEAR MIX (produced by Emtechnique Co., Ltd.), in which dispersion was carried out at a circumferential speed of 20 m/sec for 25 minutes.

Dispersion solution 20 had a turbidity of 90 ppm and dispersion particles with a number average particle diameter of 90 nm.

### Example 21

Aqueous medium (hereinafter referred to as solution B)

| | | |
|---|---|---|
| Water | 160 | L |
| Boric acid | 0.27 | kg |
| Borax | 0.23 | kg |
| 5% Nitric acid solution | 0.4 | L |
| Ethanol | 1.8 | L |
| Aqueous 25% by weight P-9 solution | 17 | L |

The above composition was mixed to obtain solution B. As inorganic particles, 32 kg of A300 were prepared.

Dispersion solution 21 was prepared according to the process as shown in FIG. 11. To disperser 1, SPM were supplied solution B at a rate of 1.71 kg/min and A300 at a rate of 0.29 kg/min to give a dispersion solution. In SMP, dispersion was carried out under conditions of a circumferential speed of 25 m/sec and a dwell time of 30 seconds. The resulting dispersion solution was supplied to a batch equipped with a dissolver type stirrer, and then supplied to disperser 2, a high pressure homogenizer (produced by Doei Shoji Co., Ltd.) wherein dispersion was carried out at a pressure of 250 kg/cm² and this was repeated three times. Thus, dispersion solution 21 was obtained.

Dispersion solution 21 had a turbidity of 15 ppm and dispersion particles with a number average particle diameter of 51 nm.

### Example 22

Dispersion solution 22 was prepared according to the process as shown in FIG. 6.

To disperser 1, SPM were supplied solution B at a rate of 1.71 kg/min and A300 at a rate of 0.29 kg/min to give a dispersion solution. In SPM, dispersion was carried out under conditions of a circumferential speed of 25 m/sec and a dwell time of 30 seconds. As dispersers 2 and 3 was used LMK in which zirconia beads having a number average bead diameter of 0.5 mm was used as beads, and dispersion in the dispersers 2 and 3 was carried out under conditions of a circumferential speed of 8 m/sec and a dwell time of 2 minutes.

The second dispersion solution ejected from disperser 2 had a turbidity of 35 ppm and dispersion particles with a number average particle diameter of 53 nm. Dispersion solution 22 had a turbidity of 13 ppm and dispersion particles with a number average particle diameter of 52 nm.

In all the examples above, the dispersion solutions, which in the dispersion step, inorganic particles and an aqueous medium were first supplied continuously to a continuous disperser 1, dispersed therein, and ejected continuously from the disperser, had no coagula. The final dispersion solutions obtained by further dispersion of the above dispersion solutions also had no coagula.

### Comparative Example 1

According to the process as shown in FIG. 1, a dispersion solution was obtained. All of solution B were placed in a batch equipped with a dissolver type stirrer, and then 32 kg of A300 were supplied at a rate of 0.29 kg/min to the batch while rotating the dissolver at a circumferential speed of 10 m/sec. After all of A300 were supplied, the resulting dispersion solution had a large number of coagula. Further dispersion was carried out for additional 60 minutes, but could not dissipate the coagula. After that, the dispersion solution was dispersed employing a high pressure homogenizer at a pressure of 250 kg/cm², and this dispersion was repeated three times. The resulting dispersion solution had a turbidity of 100 ppm and dispersion particles with a number average particle diameter of 80 nm, and was designated as dispersion solution A.

### Comparative Example 2

According to the process as shown in FIG. 2, a dispersion solution was obtained, employing a batch type disperser, Clear Mix (a high speed stirring disperser) was used as disperser 1. All of solution A were placed in the batch type disperser, Clear Mix, and then 32 kg of A300 were supplied at a rate of 0.44 kg/min to the disperser while rotating the stirrer at a circumferential speed of 20 m/sec to obtain a dispersion solution. After all of A300 were supplied, the resulting dispersion solution had a large number of coagula. Further dispersion was carried out for additional 60 minutes to obtain a dispersion solution B. Dispersion solution B had a turbidity of 130 ppm and dispersion particles with a number average particle diameter of 90 nm.

### Comparative Example 3

According to the process as shown in FIG. 2, a dispersion solution was obtained employing a batch disperser, a bead mill as disperser 1. All of solution A were placed in the batch disperser, and then 32 kg of A300 were supplied at a rate of 0.44 kg/min to the batch disperser while rotating the stirrer at a circumferential speed of 8 m/sec. After all of A300 were supplied, further dispersion was carried out for additional 25 minutes to obtain a dispersion solution C. The beads used in the bead mill were zirconia beads with a number average bead diameter of 0.5 mm, and the amount used by volume of the beads was the same as that of the dispersion solution.

Dispersion solution C had a turbidity of 72 ppm and dispersion particles with a number average particle diameter of 60 nm.

The dispersion conditions and characteristics of the dispersion solutions obtained above are shown in Tables 1 and 2.

TABLE 1

| | | | | Conditions | | | | | Dispersion solution ejected | | |
|---|---|---|---|---|---|---|---|---|---|---|---|
| | | | | Circum- | | | Conditions | | from disperser 2 | | |
| Ex- | Dispersion | | | ferential | Dwell | | Circum- | Dwell | Tur- | Number average | Concen- |
| ample | solution | | Dis- | speed | time | | ferential | time | bidity | particle | ration of |
| No. | No. | Process | perser 1 | (m/sec) | (seconds) | Disperser2 | speed (m/sec) | (seconds) | (ppm) | diameter (nm) | silica (%) |
| Ex. 1 | 1 | | SPM | 36 | 30 | SPM | 36 | 30 | 52 | 59 | 22 |
| Ex. 2 | 2 | | SPM | 11 | 30 | SPM | 11 | 30 | 290 | 70 | 22 |
| Ex. 3 | 3 | | SPM | 36 | 30 | SPM | 36 | 30 | 52 | 59 | 22 |
| Ex. 4 | 4 | | SPM | 36 | 30 | SPM | 36 | 30 | 52 | 59 | 22 |
| Ex. 5 | 5 | | SPM | 36 | 30 | FM | 25 | 0.15 | 40 | 55 | 22 |
| | *5a | | SPM | 36 | 30 | FM | 25 | 0.15 | 40 | 55 | 22 |
| Ex. 6 | 6 | | KRC | 2 | 540 | SPM | 25 | 30 | 50 | 60 | 22 |
| Ex. 7 | 7 | | SPM | 25 | 30 | SPM | 25 | 30 | 49 | 55 | 22 |
| Ex. 8 | 8 | | FJM | 25 | 20 | FM | 25 | 0.15 | 48 | 55 | 22 |
| Ex. 9 | 9 | | FJM | 25 | 20 | FJM | 25 | 20 | 49 | 55 | 22 |
| Ex. 10 | 10 | | FJM | 11 | 20 | Batch | 8 | 1500 | | | |
| | | | | | | bead | | | | | |
| | | | | | | mill | | | | | |
| Ex. 11 | 11 | | FJM | 11 | 20 | FJM | 11 | 20 | 200 | 68 | 28 |
| Ex. 12 | 12 | | FJM | 25 | 20 | FJM | 25 | 20 | 49 | 54 | 22 |
| Ex. 13 | 13 | | FJM | 25 | 20 | FJM | 25 | 20 | 49 | 53 | 22 |
| Ex. 14 | 14 | | FJM | 25 | 20 | FJM | 25 | 20 | 48 | 55 | 22 |
| Ex. 15 | 15 | | FJM | 25 | 20 | FJM | 25 | 20 | 45 | 54 | 22 |
| Ex. 16 | 16 | | FJM | 25 | 20 | FJM | 25 | 20 | 48 | 52 | 22 |
| Ex. 17 | 17 | | FJM | 25 | 20 | FM | 25 | 0.15 | not | not measured | 35 |
| | | | | | | | | | measured | | |
| Ex. 18 | 18 | | FJM | 25 | 20 | FM | 25 | 0.15 | 150 | 70 | 13 |
| Ex. 19 | 19 | | FJM | 25 | 20 | FM | 25 | 0.15 | 150 | 140 | 22 |
| Ex. 20 | 20 | | FJM | 11 | 20 | CM | 20 | dispersed | | | |
| | | | | | | | | for 25 min | | | |

| | | | | | | | | | |
|---|---|---|---|---|---|---|---|---|---|
| Ex. 21 | 21 | SPM | 25 | 30 | MG | dispersed three times at a | | | |
| | | | | | | pressure of 250 kg/cm² | | | |
| Ex. 22 | 22 | SPM | 25 | 30 | LMK | dwell time of 2 minutes | 35 | 53 | 16 |
| Comp. | A | D | 10 | dispersed | MG | dispersed at a pressure of | | | |
| Ex. 1 | | | | for | | 250 kg/cm² three times | | | |
| | | | | 170 min | | | | | |
| Comp. | B | CM | 20 | dispersed | — | — | | | |
| Ex. 2 | | | | for | | | | | |
| | | | | 130 min | | | | | |
| Comp. | C | Batch | 8 | 6000 | — | — | | | |
| Ex. 3 | | bead | | | | | | | |
| | | mill | | | | | | | |

*This example is regarded as a dispersion solution obtained according to the process as shown in FIG. 3.

| | | | Conditions | | Final dispersion | | | | | | |
|---|---|---|---|---|---|---|---|---|---|---|---|
| | | | Number | | | Number | Concen- | | | | |
| | | | average bead | Dwell | | average | tration | | | | |
| Example | Dispersion | Disperser | diameter | time | Turbidity | particle | of silica | Cationic | Boric acid | Silica | |
| No. | solution No. | 3 | (mm) | (minutes) | (ppm) | diameter (nm) | (%) | polymer | borax | used | Remarks |
| Ex. 1 | 1 | LMK | 0.5 | 2 | 18 | 53 | 22 | P-9 | Yes | Gas | Invention |
| | | | | | | | | | | phase | |
| | | | | | | | | | | method | |
| Ex. 2 | 2 | LMK | 0.5 | 2 | 50 | 60 | 22 | P-9 | Yes | Gas | Invention |
| | | | | | | | | | | phase | |
| | | | | | | | | | | method | |
| Ex. 3 | 3 | LMK | 2.0 | 25 | 48 | 56 | 22 | P-9 | Yes | Gas | Invention |
| | | | | | | | | | | phase | |
| | | | | | | | | | | method | |
| Ex. 4 | 4 | LMK | 0.5 | 25 | 17 | 51 | 22 | P-9 | Yes | Gas | Invention |
| | | | | | | | | | | phase | |
| | | | | | | | | | | method | |
| Ex. 5 | 5 | LMK | 0.5 | 2 | 16 | 53 | 22 | P-9 | Yes | Gas | Invention |
| | | | | | | | | | | phase | |
| | | | | | | | | | | method | |
| Ex. 6 | 6 | LMK | 0.5 | 2 | 16 | 55 | 22 | P-9 | Yes | Gas | Invention |
| | | | | | | | | | | phase | |
| | | | | | | | | | | method | |
| Ex. 7 | 7 | LMK | 0.5 | 2 | 17 | 54 | 22 | P-9 | Yes | Gas | Invention |
| | | | | | | | | | | phase | |
| | | | | | | | | | | method | |
| Ex. 8 | 8 | LMK | 0.5 | 2 | 10 | 51 | 22 | P-9 | Yes | Gas | Invention |
| | | | | | | | | | | phase | |
| | | | | | | | | | | method | |
| Ex. 9 | 9 | LMK | 0.5 | 1.4 | 15 | 52 | 14.5 | P-9 | Yes | Gas | Invention |
| | | | | | | | | | | phase | |
| | | | | | | | | | | method | |
| Ex. 10 | 10 | — | — | — | 60 | 60 | 22 | P-9 | Yes | Gas | Invention |
| | | | | | | | | | | phase | |
| | | | | | | | | | | method | |
| Ex. 11 | 11 | Batch | 0.5 | 2 | 30 | 54 | 22 | P-9 | Yes | Gas | Invention |
| | | bead | | | | | | | | phase | |
| | | mill | | | | | | | | method | |
| Ex. 12 | 12 | Batch | 0.5 | 2 | 30 | 50 | 22 | P-9 | Yes | Gas | Invention |
| | | bead | | | | | | | | phase | |
| | | mill | | | | | | | | method | |
| Ex. 13 | 13 | Batch | 0.5 | 2 | 10 | 52 | 14.5 | P-9 | Yes | Gas | Invention |
| | | bead | | | | | | | | phase | |
| | | mill | | | | | | | | method | |
| Ex. 14 | 14 | LMK | 0.5 | 1.4 | 13 | 50 | 14.5 | P-10 | Yes | Gas | Invention |
| | | | | | | | | | | phase | |
| | | | | | | | | | | method | |
| Ex. 15 | 15 | LMK | 0.5 | 1.4 | 17 | 49 | 14.5 | P-9 | none | Gas | Invention |
| | | | | | | | | | | phase | |
| | | | | | | | | | | method | |
| Ex. 16 | 16 | LMK | 0.5 | 1.4 | 14 | 52 | 14.5 | none | Yes | Gas | Invention |
| | | | | | | | | | | phase | |
| | | | | | | | | | | method | |
| Ex. 17 | 17 | LMK | 0.5 | 2 | 18 | 48 | 35 | P-9 | Yes | Gas | Invention |
| | | | | | | | | | | phase | |
| | | | | | | | | | | method | |
| Ex. 18 | 18 | LMK | 0.5 | 2 | 10 | 53 | 13 | P-9 | Yes | Gas | Invention |
| | | | | | | | | | | phase | |
| | | | | | | | | | | method | |
| Ex. 19 | 19 | LMK | 0.5 | 2 | 30 | 60 | 22 | P-9 | Yes | Wet | Invention |
| | | | | | | | | | | method | |
| Ex. 20 | 20 | — | — | — | 90 | 90 | 22 | P-9 | Yes | Gas | Invention |
| | | | | | | | | | | phase | |
| | | | | | | | | | | method | |
| Ex. 21 | 21 | — | — | — | 15 | 51 | 16 | P-9 | Yes | Gas | Invention |
| | | | | | | | | | | phase | |
| | | | | | | | | | | method | |
| Ex. 22 | 22 | LMK | 0.5 | 2 | 13 | 52 | 16 | P-9 | Yes | Gas | Invention |
| | | | | | | | | | | phase | |
| | | | | | | | | | | method | |
| Comp. Ex. 1 | A | — | — | — | 100 | 80 | 16 | P-9 | Yes | Gas | Compara- |
| | | | | | | | | | | phase | tive |
| | | | | | | | | | | method | |
| Comp. Ex. 2 | B | — | — | — | 130 | 90 | 22 | P-9 | Yes | Gas | Compara- |
| | | | | | | | | | | phase | tive |
| | | | | | | | | | | method | |
| Comp. Ex. 3 | C | — | — | — | 105 | 60 | 22 | P-9 | Yes | Gas | Compara- |
| | | | | | | | | | | phase | tive |
| | | | | | | | | | | method | |

TABLE 3

| | Trade name of | |
|---|---|---|
| Disperser | disperser | Remarks |
| SPM | Spiral Pin Mixer | Pin mixer type continuous |
| | | kneading disperser |
| FJM | Flow Jet Mixer | Pin mixer type continuous |
| | | kneading disperser |
| FM | Fine Flow Mill | High speed stirring |
| | | continuous pulverizing |
| | | disperser |
| LMK | LMK | Wet media type |
| | | continuous pulverizing |
| | | disperser |
| KRC | KRC Kneader | Continuous kneader |
| CM | Clear Mix | Batch type high speed |
| | | stirring pulverizing |
| | | disperser |
| D | — | Dissolver type stirrer |
| MG | Mantongorin | High pressure homogenizer |
| | Homogenizer | |

As is apparent from the above, inventive examples provided excellent production efficiency without forming coagula.

### Example 23

(Preparation of titanium oxide dispersion solution-1)

Twenty kilograms of titanium oxide particles (W-10, produced by Ishihara Sangyo Co., Ltd.) having a number average particle diameter of 0.25 μm were added to 90 L of an aqueous solution with a pH of 7.5 containing 150 g of sodium tripolyphosphate, 500 g of polyvinyl alcohol (PVA235, produced by Kuraray Co., Ltd.), 150 g of cationic polymer (P-9) and 10 g of a defoaming agent SN381 (produced by Sannobuko Co., Ltd.) in a high pressure homogenizer (produced by Sanwa Kogyo Co., Ltd.), and dispersed. Water was added to make a 100 L dispersion solution. Thus, titanium oxide dispersion solution-1 was obtained.

(Preparation of Fluorescent Brightening Agent Dispersion Solution-1)

Four hundred grams of oil soluble fluorescent brightening agent UVITEX-OB (produced by Chiba Geigy Co., Ltd.) were added to a mixture solution of 9000 g of diisodecylphthalate and 12 L of ethyl acetate, heated to obtain a solution, and the resulting solution was mixed with 65 L of an aqueous solution containing 3500 g of acid-processed gelatin, 0.8 kg of cationic polymer, P-1 and 6,000 ml of a 50% saponin solution. The resulting mixture was dispersed at a pressure of 250 kg/cm² three times in a high pressure homogenizer (produced by Sanwa Kogyo Co., Ltd.). After the ethyl acetate was distilled out under reduced pressure, water was added to make a 100 L dispersion solution. Thus, fluorescent brightening agent dispersion solution-1 was obtained.

(Preparation of Coating Solution)

Each of the dispersion solutions obtained in examples and comparative examples above was diluted with water to give a silica concentration by weight of 10%. The following solutions and emulsion were added in the order while stirring at 40° C. to 600 ml of the resulting dispersion solution above.

| | | | |
|---|---|---|---|
| 1. | Aqueous 10% solution of polyvinyl alcohol | 0.6 | ml |
| | (PVA202, produced by Kuraray Co., Ltd.) | | |
| 2. | Aqueous 5% solution of polyvinyl alcohol (PVA235, | 260 | ml |
| | produced by Kuraray Co., Ltd.) | | |
| 3. | Fluorescent brightening agent dispersion | 25 | ml |
| | solution-1 | | |
| 4. | Titanium oxide dispersion solution-1 | 33 | ml |
| 5. | Latex emulsion (AE-803, produced by Daiichi Kogyo | 18 | ml |
| | Co., Ltd.) | | |
| 6. | Pure water was added to make a 1,000 ml solution | | |

Thus, coating solution was obtained.

(Preparation of Recording Medium)

The resulting coating solution was coated on a 220 μm thick paper support, in which a polyethylene film was laminated on both surfaces of a base paper, to give a wet thickness of 200 μm. Herein, in the paper support, the polyethylene film laminated on the surface of the base paper on the ink absorption layer side contained an anatase type titanium oxide in an amount of 13% by weight.

Immediately after each coating solution was coated at 40° C. employing a slide hopper, the coated material was cooled at 0° C. for 20 seconds, and dried supplying an air of 25° C. and 15% RH for 60 seconds, supplying an air of 45° C. and 25% RH for 60 seconds, and then supplying an air of 50° C. and 25% RH for 60 seconds. The resulting material was rehumidified at 20 to 25° C. and 40 to 60%RH for 2 minutes. Thus, recording mediums 1 through 22, recording medium 5a, and recording mediums A, B, and C were obtained.

Recording mediums 1 through 22, recording medium 5a, and recording mediums A, B, and C were evaluated as follows:

(1) Glossiness

Glossiness was measured at an angle of 75 degree employing a glossmeter, VGS-1001DP produced by Nihon Denshoku Kogyo Co., Ltd. The higher the value, the better the glossiness.

(2) Cracks

The coated layer surface of 0.3 m² was visually observed, and the number of cracks was counted. Cracks of not more than 10 are not problematic for practical use.

(3) Maximum Density

Magenta solid image was printed on the recording mediums by means of an ink-jet printer PM 750C, produced by Seiko Epson Co., Ltd., and its maximum reflection density was measured.

The results are shown in Table 4.

TABLE 4

| | | Turbidity | | | | |
|---|---|---|---|---|---|---|
| Re- | | of | | | | |
| cording | Dispersion | dispersion | Glossi- | | | |
| medium | solution | solution | | ness | Maximum | Re- |
| No. | No. | (ppm) | Cracks | (%) | density | marks |
| 1 | 1 | 18 | 3 | 56 | 20.5 | Inv. |
| 2 | 2 | 50 | 10 | 50 | 1.96 | Inv. |
| 3 | 3 | 48 | 9 | 51 | 1.98 | Inv. |
| 4 | 4 | 17 | 3 | 55 | 2.06 | Inv. |
| 5 | 5 | 16 | 2 | 55 | 2.1 | Inv. |
| 5a | 5a | 40 | 5 | 52 | 2 | Inv. |
| 6 | 6 | 16 | 2 | 55 | 2.11 | Inv. |
| 7 | 7 | 17 | 3 | 55 | 2.08 | Inv. |
| 8 | 8 | 10 | 0 | 61 | 2.14 | Inv. |
| 9 | 9 | 15 | 1 | 56 | 2.12 | Inv. |
| 10 | 10 | 60 | 10 | 47 | 1.9 | Inv. |
| 11 | 11 | 30 | 4 | 54 | 2.02 | Inv. |
| 12 | 12 | 10 | 0 | 60 | 2.14 | Inv. |
| 13 | 13 | 13 | 0 | 58 | 2.12 | Inv. |
| 14 | 14 | 17 | 3 | 56 | 2.05 | Inv. |
| 15 | 15 | 14 | 10 | 57 | 2.14 | Inv. |
| 16 | 16 | 18 | 3 | 56 | 1.82 | Inv. |
| 17 | 17 | 10 | 0 | 62 | 2.14 | Inv. |
| 18 | 18 | 45 | 8 | 51 | 1.99 | Inv. |
| 19 | 19 | 30 | 7 | 54 | 2.01 | Inv. |
| 20 | 20 | 90 | 10 | 45 | 1.82 | Inv. |
| 21 | 21 | 15 | 3 | 56 | 2.01 | Inv. |
| 22 | 22 | 13 | 1 | 59 | 2.09 | Inv. |
| A | A | 100 | 56 | 30 | 1.65 | Comp. |
| B | B | 130 | 100 | 36 | 1.55 | Comp. |
| C | C | 105 | 60 | 40 | 1.73 | Comp. |

Inv.: Invention, Comp.: Comparative

As is apparent from Table 4 above, inventive processes improved productivity, and inventive recording mediums manufactured according to the invention provided reduced density.

[Effects of the Invention]

As is shown in the above examples, the process of the invention for manufacturing an ink-jet recording medium improved productivity, and the ink-jet recording medium manufactured according to the process provided reduced cracks, high glossiness and high density.

What is claimed is:

1. A process for manufacturing a recording medium for ink-jet recording, the process comprising the steps of:
1) supplying continuously at least inorganic particles and an aqueous medium to a disperser;
2) dispersing the inorganic particles in the disperser to obtain an inorganic particle dispersion solution;
3) ejecting continuously the dispersion solution from the disperser, wherein the supplying, dispersing, and ejecting are carried at the first dispersion stage;
4) providing a coating solution containing the resulting inorganic particle dispersion solution; and
5) coating the coating solution on a support.

2. The process of claim 1, wherein the disperser is a kneading disperser or a pulverizing disperser.

3. The process of claim 1, wherein the inorganic particle dispersion solution has a turbidity of not more than 50 ppm.

4. The process of claim 1, wherein the inorganic particle dispersion solution further contains a cationic polymer.

5. The process of claim 1, wherein the inorganic particles are silica particles.

6. A process for manufacturing a recording medium for ink-jet recording, the process comprising the steps of:
1) supplying continuously at least inorganic particles and an aqueous medium to a first disperser;
2) dispersing the inorganic particles in the first disperser to obtain a first inorganic particle dispersion solution;
3) ejecting continuously the first dispersion solution from the first disperser;
4) supplying continuously the ejected first dispersion solution to a second disperser;
5) dispersing the first dispersion solution in the second disperser to obtain a second inorganic particle dispersion solution;
6) ejecting continuously the second dispersion solution from the second disperser, wherein the steps 1), 2), 3), 4), 5) and 6) are carried out in the first dispersion stage;
7) providing a coating solution containing the ejected second inorganic particle dispersion solution; and
8) coating the coating solution on a support.

7. The process of claim 6, wherein the first disperser and the second disperser are connected in series.

8. The process of claim 6, wherein the inorganic particle dispersion solution has a turbidity of not more than 50 ppm.

9. A process for manufacturing a recording medium for ink-jet recording, the process comprising the steps of:
1) supplying continuously at least inorganic particles and an aqueous medium to a first disperser;
2) dispersing inorganic particles in the first disperser to obtain a first inorganic particle dispersion solution;
3) ejecting continuously the first dispersion solution from the first disperser;
4) supplying continuously the ejected first dispersion solution to a second disperser;
5) dispersing the first dispersion solution in the second disperser to obtain a second inorganic particle dispersion solution;
6) ejecting continuously the second dispersion solution from the second disperser;
7) supplying continuously the ejected second dispersion solution to a third disperser;
8) dispersing the second dispersion solution in the third disperser to obtain a third inorganic particle dispersion solution;
9) ejecting continuously the third dispersion solution from the third disperser, wherein the steps 1), 2), 3), 4), 5), 6), 7), 8) and 9) are carried out in the first dispersion stage;
10) providing a coating solution containing the ejected third inorganic particle dispersion solution; and
11) coating the coating solution on a support.

10. The process of claim 9, wherein the first disperser, the second disperser and the third disperser are connected in series.

11. The process of claim 9, wherein at least one of the first and second dispersers is a kneading disperser.

12. The process of claim 11, wherein the kneading disperser has a rotor with a circumferential speed of 10 to 40 m/second.

13. The process of claim 9, wherein the dwell time of the first dispersion solution in the first disperser and the dwell time of the second dispersion solution in the second disperser are each 0.1 to 600 seconds.

14. The process of claim 9, wherein the third disperser is a pulverizing disperser.

15. The process of claim 14, wherein the pulverizing disperser employs beads with a number average particle diameter of 0.2 to 2 mm as a dispersing medium.

16. The process of claim 9, wherein the dwell time of the third dispersion solution in the third disperser is 1 to 30 minutes.

17. The process of claim 9, wherein the second dispersion solution ejected from the second disperser has a turbidity of not more than 300 ppm.

18. The process of claim 9, wherein the third dispersion ejected from the third disperser has a turbidity of not more than 50 ppm.

19. The process of claim 9, wherein the inorganic particles are silica particles.
